(19) United States
(12) Patent Application Publication
(10) Pub. No.: US 2015/0224652 A1
(43) Pub. Date: Aug. 13, 2015

(54) BLADED APPARATUS HAVING IMPROVED GRIPPING

(71) Applicant: Robert Irvin, Hilliard, OH (US)

(72) Inventor: Robert Irvin, Hilliard, OH (US)

(21) Appl. No.: 14/620,298

(22) Filed: Feb. 12, 2015

Related U.S. Application Data
(60) Provisional application No. 61/938,926, filed on Feb. 12, 2014.

(51) Int. Cl. B26B 3/00; B26B 1/02; F41B 13/00

(52) U.S. Cl. CPC B26B 3/00; F41B 13/00; B26B 1/02

(57) ABSTRACT

A bladed apparatus comprising: a tool having (1) a first end; (2) a second end; and (3) a spine positioned between said first end and said second end, and a handle portion configured to hold said tool, said handle portion being located between said safety ring portion and said blade portion. A safety ring portion may be positioned at the first end, and a blade portion may be positioned at the second end, with the blade portion comprising an inside edge, an outside edge, and a point. The safety ring portion may comprise, along its outer periphery, (a) a mid-lock portion; (b) a thumb lock portion; and (c) a reverse lock portion.

### CROSS-REFERENCE TO RELATED APPLICATIONS

This application claims priority to U.S. Provisional Patent Application No. 61/938,926, filed on Feb. 12, 2014, entitled “Karambit with Features Allowing Better Gripping and More Effective Utilization,” by Robert Irvin, which is hereby incorporated by reference in its entirety.

### TECHNICAL FIELD

The article described as set forth herein is a novel cutting apparatus, specifically a karambit, with novel features that allow the operator improved control and stability of the karambit in different positions and functions.

### BACKGROUND

The karambit was originally developed in Asia as an agricultural implement designed to rake roots, gather threshing and plant rice. More recently, the western world discovered that the karambit would be useful for self-defense. Those modern-day karambits produced in the western world for use as weapons are generally based on a small variety of the karambit, which features a short blade and index finger ring.

The karambit's general features, which sometimes include an inside concave edge and an outside convex edge, along with a point, and a safety ring for the forefinger to allow weapon maneuverability and retention along with its small size, make it an ideal weapon for concealment and allow for powerful slashes and stabs at close range. Both fixed blade (generally double-edged) and folding (generally single-edged) karambits are produced by a number of makers, including, for example, Warren Thomas, Mantis Knives, Emerson Knives, Strider Knives, Spyderco, Cold Steel, Craig Camerer, United Cutlery, Rich Derespina, Cutters Knife and Tool, 5.11 Tactical, Kramer Custom Knives, Tom Ferry Knives, Mike Snody, Quartermaster Knives, Tindle Knives, and Fox Cutlery. The flexibility of striking methods is what makes the karambit so useful in self-defense situations.

Effective use of the karambit results in the operator handling the weapon using different style grip positions, including, inter alia, an extended grip position or a reverse grip position. Due to its compact size, the karambit has a small reach. The karambit's reach may be increased by employing the extended grip position; however, the extended grip position is inherently weak and results in unstable handling.

A reverse grip position may be employed to facilitate a hammering motion. Applying downward force on the karambit with the thumb resting on the convex side of the safety ring (thumb would be effectively resting on a point) exposes another inherent weakness of the modern-day karambit design. Under extreme conditions, the karambit might become unstable and twist in the operator's hand, or apply excessive pressure to the thumb at the point of contact (thumb contacting convex side of the safety ring). Such conditions render the weapon less effective, and could become a nuisance to the operator.

Further, the safety ring on the karambit can be used in a punching motion, hitting the opponent with the finger safety ring; this imitates a brass knuckle. Use of the existing safety ring design is not very effective; however, modifying the safety ring design to function more like a brass knuckle will render the karambit a better weapon.

Thus, a need exists for increasing stability of the karambit when in an extended grip position, and/or the reverse grip position, thereby improving the effectiveness, comfort, and usability of the karambit.

### SUMMARY OF THE INVENTION

The present disclosure is directed to a bladed apparatus having one or more of the following features, or combinations thereof, disclosed herein or in the Detailed Description below.

According to a first aspect, a bladed apparatus comprises: a generally C-shaped tool having (1) a first end; (2) a second end; and (3) a spine positioned between said first end and said second end, wherein a safety ring portion is positioned at the first end, and a blade portion is positioned at the second end, the blade portion comprising an inside edge, an outside edge, and a point, and wherein safety ring portion comprises along its outer periphery (a) a mid-lock portion; (b) a thumb lock portion; and (c) a reverse lock portion, and a handle portion configured to hold said C-shaped tool, at least a portion of said handle portion being located between said safety ring portion and said blade portion.

According to a second aspect, a bladed apparatus comprises: a tool having (1) a first end; (2) a second end; and (3) a spine positioned between said first end and said second end, wherein a safety ring portion is positioned at the first end, and a blade portion is positioned at the second end, the blade portion comprising an inside edge, an outside edge, and a point, and wherein safety ring portion comprises along its outer periphery (a) a mid-lock portion; (b) a thumb lock portion; and (c) a reverse lock portion, and a handle portion configured to hold said tool, at least a portion of said handle portion being located between said safety ring portion and said blade portion.

In certain aspects, (1) said mid-lock portion has a radial geometry and the mid-lock may also be concave; (2) said thumb lock portion has a concave geometry; and/or (3) said reverse lock portion has a concave geometry.

In certain aspects, said generally C-shaped tool is fabricated from a single, continuous material. Conversely, the C-shaped tool may be fabricated from two pieces. Thus, the C-shaped tool may be fabricated from a discontinuous material, wherein the blade portion is configured to pivot with regard to the spine.

In certain aspects, said single, continuous material is a ferrous metal material.

In certain aspects, said single, continuous material is a polymer-based composite resinous material.

In certain aspects, said handle portion is wood, and/or a polymer material.

### DESCRIPTION OF THE DRAWING

FIG. 1a illustrates the general components of a modern-day karambit.

FIG. 1b illustrates the karambit of FIG. 1a in an extended grip position.

FIG. 1c illustrates the karambit of FIG. 1a in a reverse grip position.

FIG. 2a illustrates an outline drawing of a straight edge karambit tool in accordance with an aspect of the present invention.

FIG. 2b illustrates a straight edge karambit tool in accordance with an aspect of the present invention.

FIG. 2c illustrates a top plan view of the straight edge karambit tool with a handle assembly in accordance with an aspect of the present invention.

FIG. 2d illustrates the opposite side of the straight edge karambit of FIG. 2c.

FIG. 2e illustrates the top side of the straight edge karambit of FIG. 2c.

FIG. 2f illustrates the bottom side of the straight edge karambit of FIG. 2c.

FIG. 2g illustrates the front (tip) end of the straight edge karambit of FIG. 2c.

FIG. 2h illustrates the rear end of the straight edge karambit of FIG. 2c.

FIG. 3a illustrates an outline drawing of a curved edge karambit tool in accordance with an aspect of the present invention.

FIG. 3b illustrates a curved edge karambit in accordance with an aspect of the present invention.

FIG. 3c illustrates a top plan view of the curved edge karambit tool with a handle assembly in accordance with an aspect of the present invention.

FIG. 3d illustrates the opposite side of the curved edge karambit of FIG. 3c.

FIG. 3e illustrates the top side of the curved edge karambit of FIG. 3c.

FIG. 3f illustrates the bottom side of the curved edge karambit of FIG. 3c.

FIG. 3g illustrates the front end of the curved edge karambit of FIG. 3c.

FIG. 3h illustrates the rear end of the curved edge karambit of FIG. 3c.

FIG. 4a illustrates a partly folded folding straight edge karambit tool with a handle assembly in accordance with an aspect of the present invention.

FIG. 4b illustrates a top plan view of the folding straight edge karambit of FIG. 4a in an extended position.

FIG. 4c illustrates the opposite side of the folding straight edge karambit of FIG. 4a.

FIG. 4d illustrates the top side of the folding straight edge karambit of FIG. 4a.

FIG. 4e illustrates the bottom side of the folding straight edge karambit of FIG. 4a.

FIG. 4f illustrates the front end of the folding straight edge karambit of FIG. 4a.

FIG. 4g illustrates the rear end of the folding straight edge karambit of FIG. 4a.

FIG. 5a illustrates a straight edge karambit in an extended grip position.

FIG. 5b illustrates a straight edge karambit in a reverse grip position.

### DETAILED DESCRIPTION

The present disclosure is directed to novel cutting apparatuses, specifically a karambit, with novel features that allow the operator improved control and stability of the karambit in different positions and functions. Preferred embodiments of the present invention will be described herein below with reference to the figures of the accompanying drawing. In the following description, well-known functions or constructions are not described in detail, since such descriptions would obscure the invention in unnecessary detail.

For the purpose of promoting an understanding of the principles of the claimed technology and presenting its currently understood best mode of operation, reference will be now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

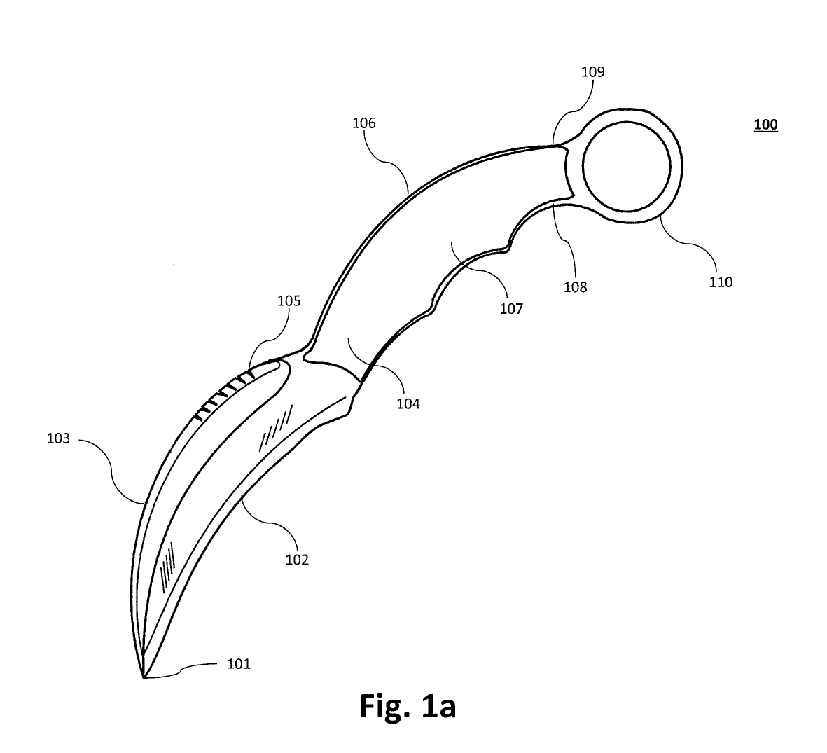

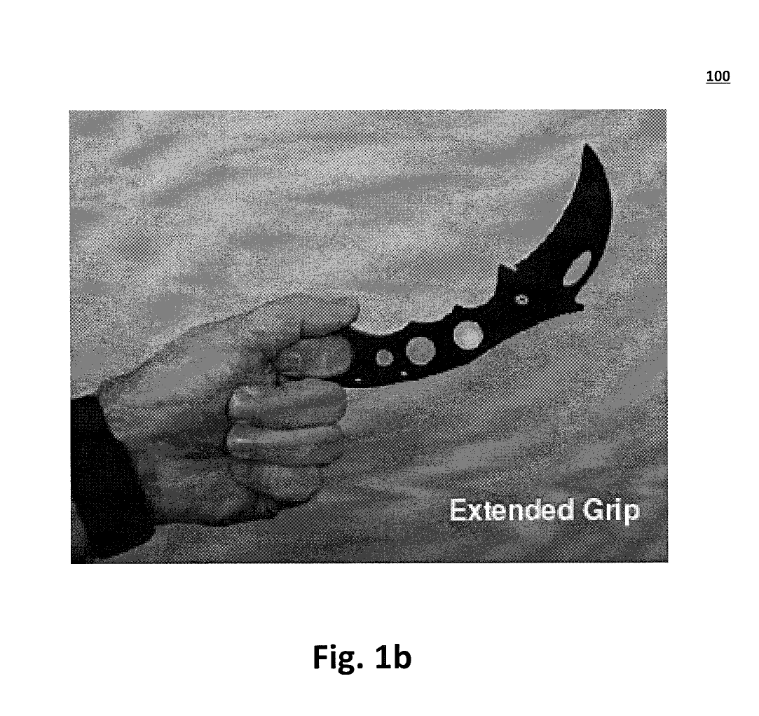

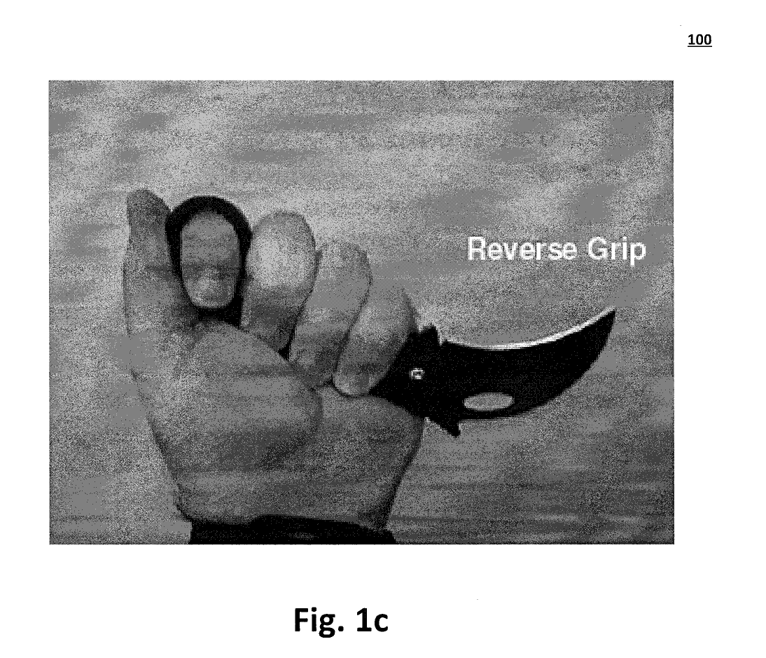

FIG. 1a illustrates the general components of a modern-day karambit 100. As illustrated, a modern-day karambit 100 generally comprises a point 101, an inside edge 102, an outside edge 103, a shaft 104, a back blade 105, a spine 106, a handle 107, a front brake 108, a rear brake 109, and a safety ring 110. As discussed above, the safety ring 110 on the modern-day karambit 100 can be used in a punching motion, hitting the opponent with the finger safety ring, but suffers from a number of limitations, thereby resulting in poor, ineffective handling. Such poor, ineffective handling is illustrated in, for example, FIGS. 1b and 1c, which illustrate a modern-day karambit 100 in an extended grip position, and a reverse grip position, respectively.

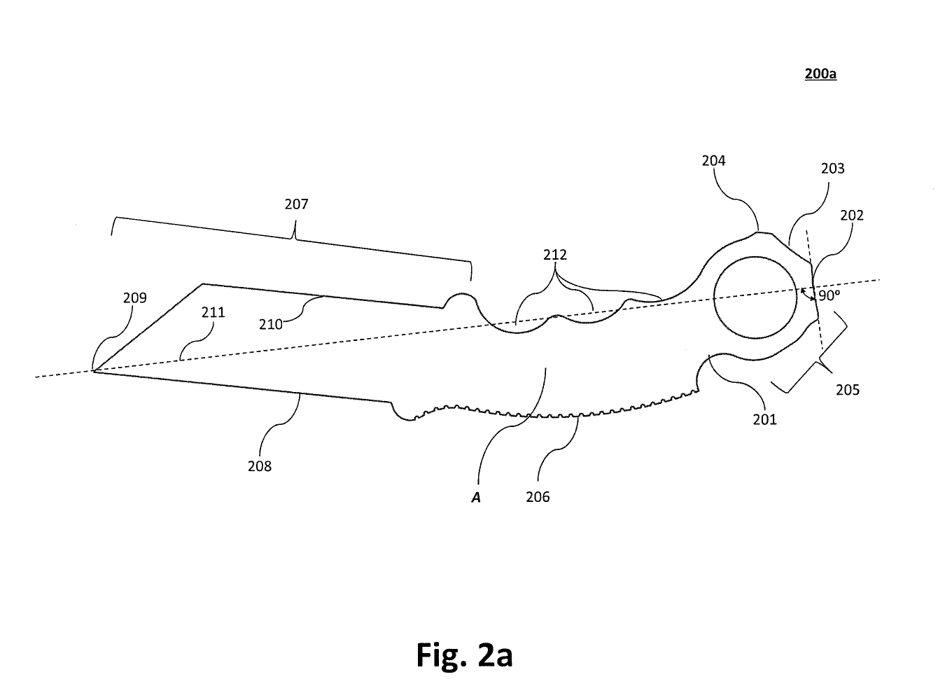

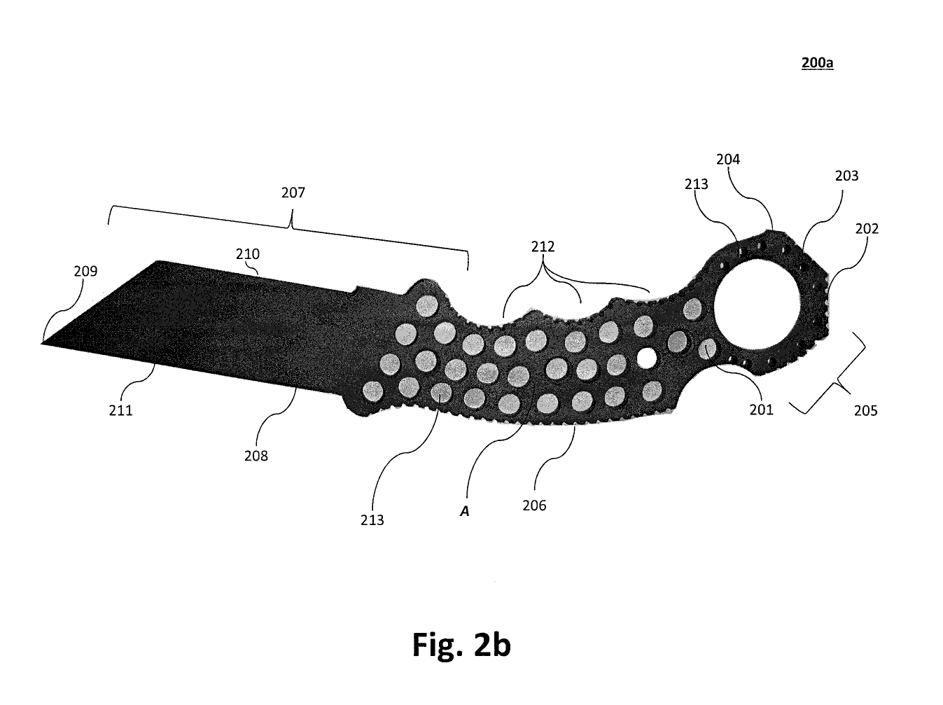

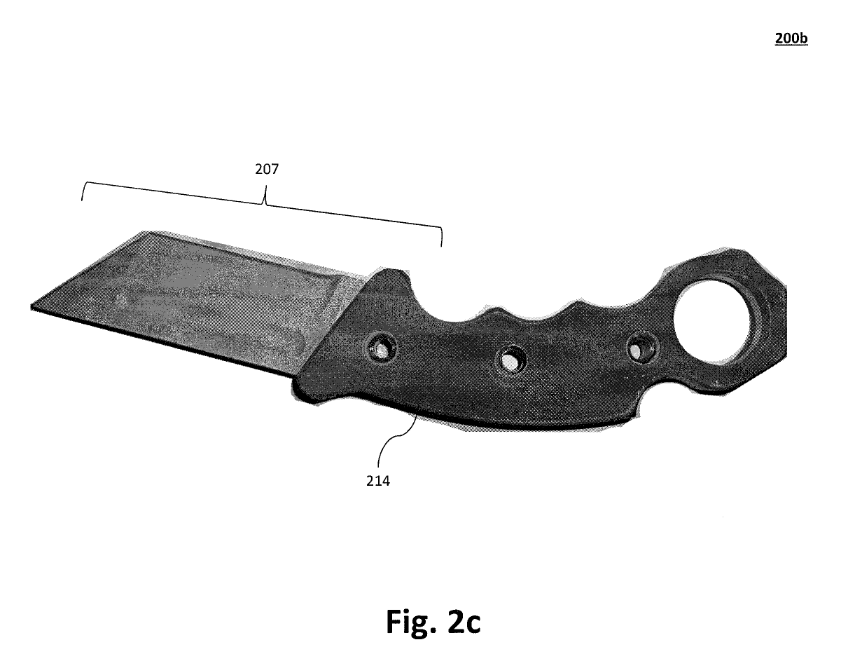

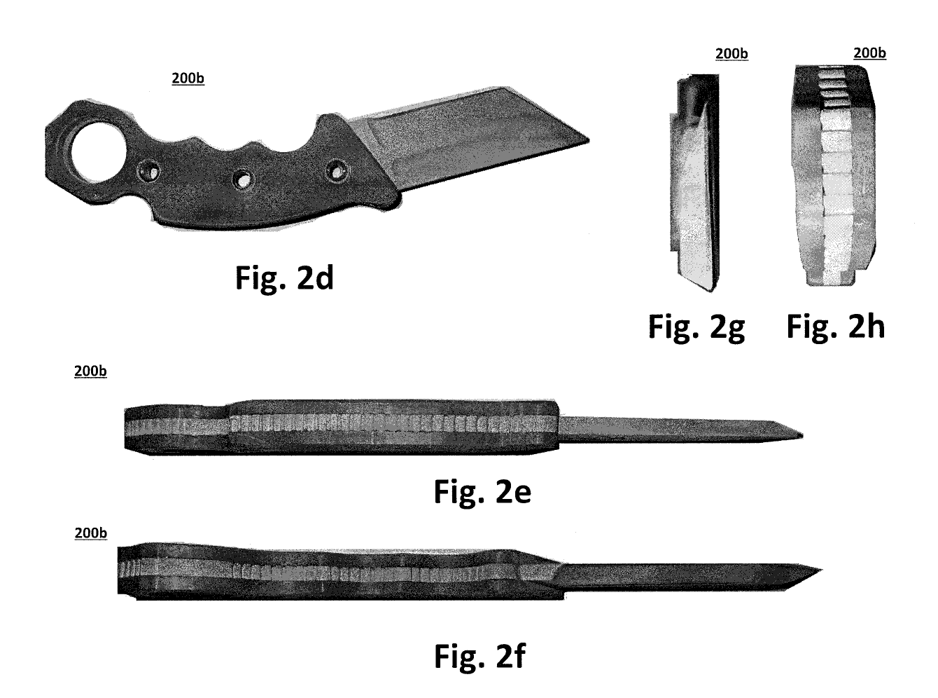

FIG. 2a illustrates a side profile view of a straight edge karambit tool 200a in accordance with an aspect of the present invention. The straight edge karambit tool 200a shares certain of the components with the modern-day karambit 100. For example, the straight edge karambit tool 200a may comprise an inside edge 210, an outside edge 208, a safety ring, and a spine 206. To increase comfort, as illustrated in FIGS. 2c through 2f, a handle 214 may be positioned on each side of (or around) the spine 206 (e.g., at point A) to form a complete (e.g., assembled) straight edge karambit 200b.

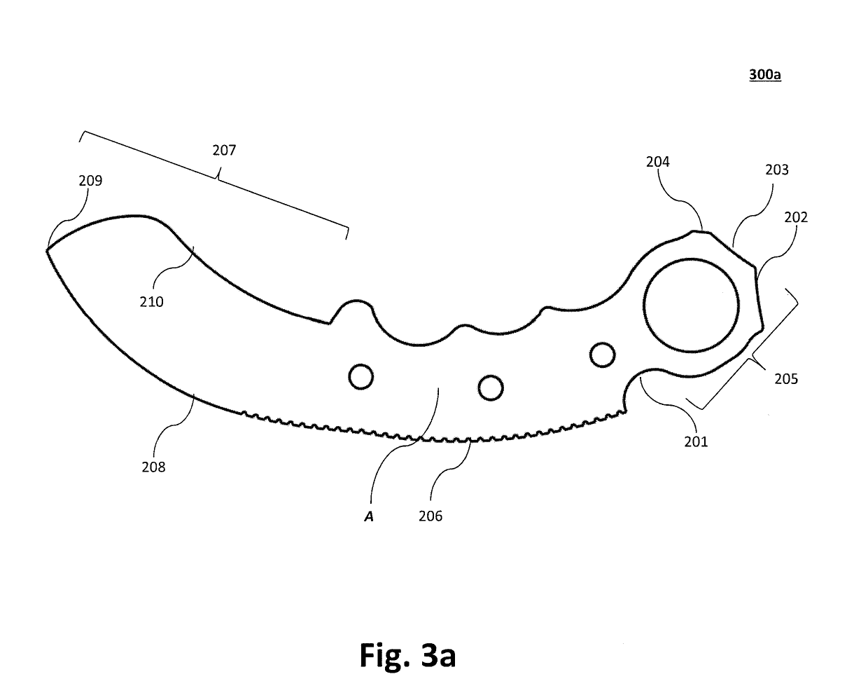

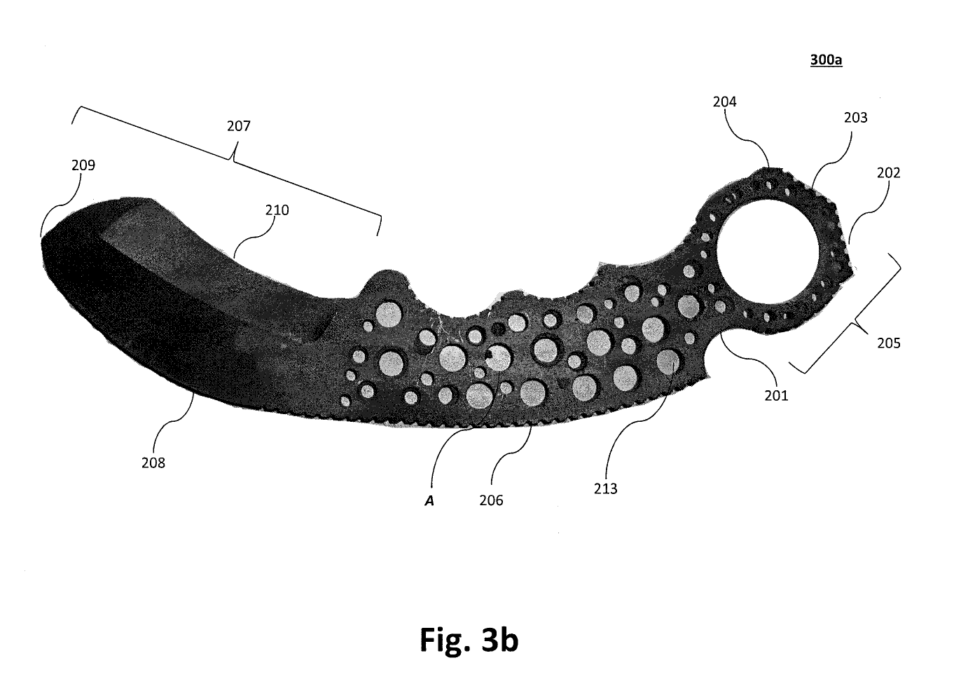

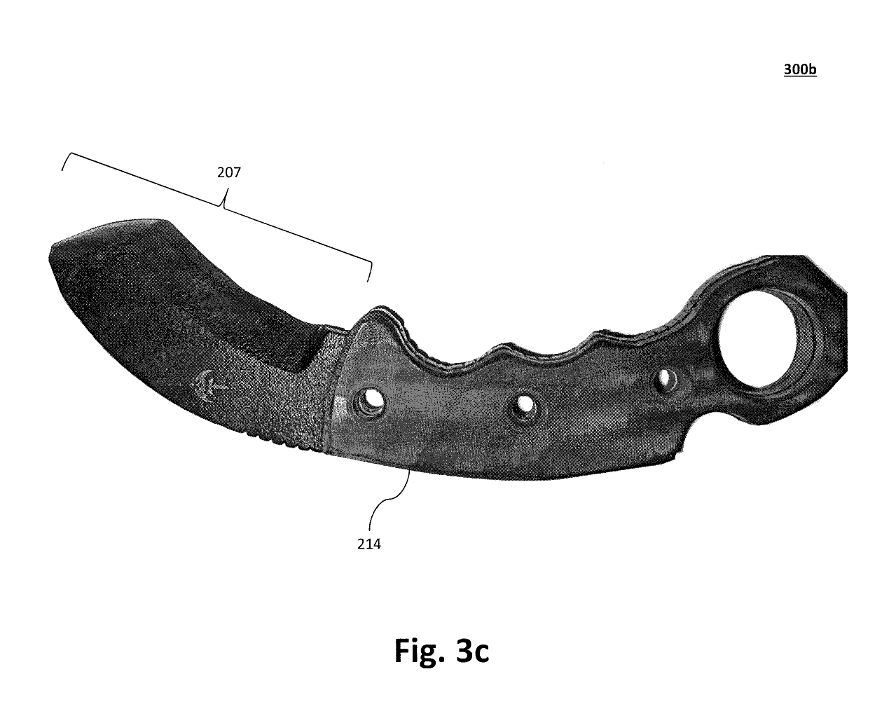

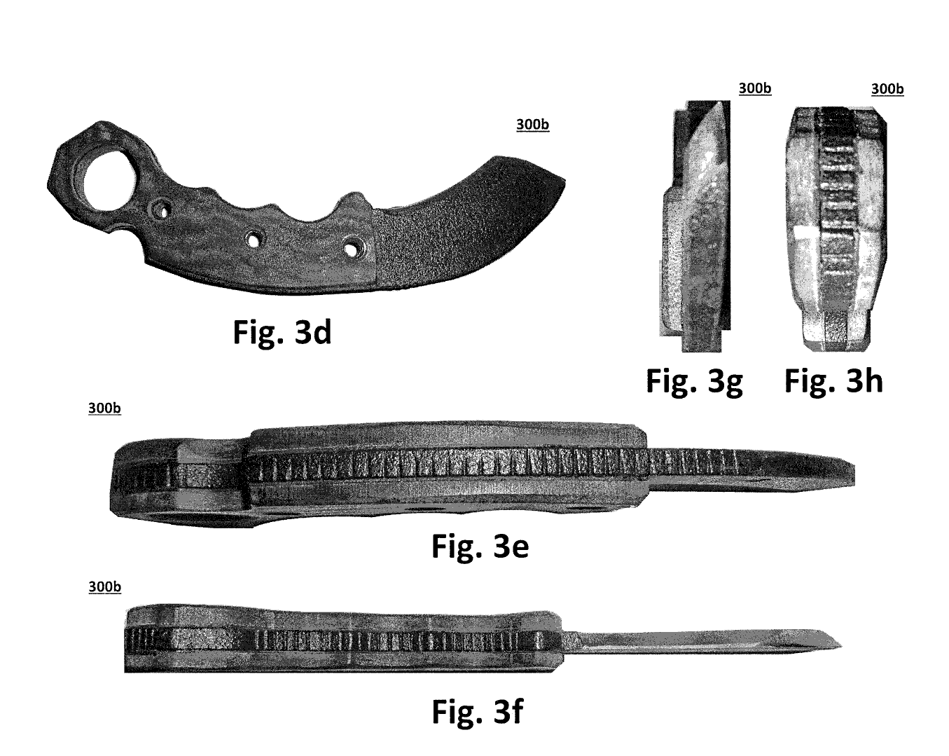

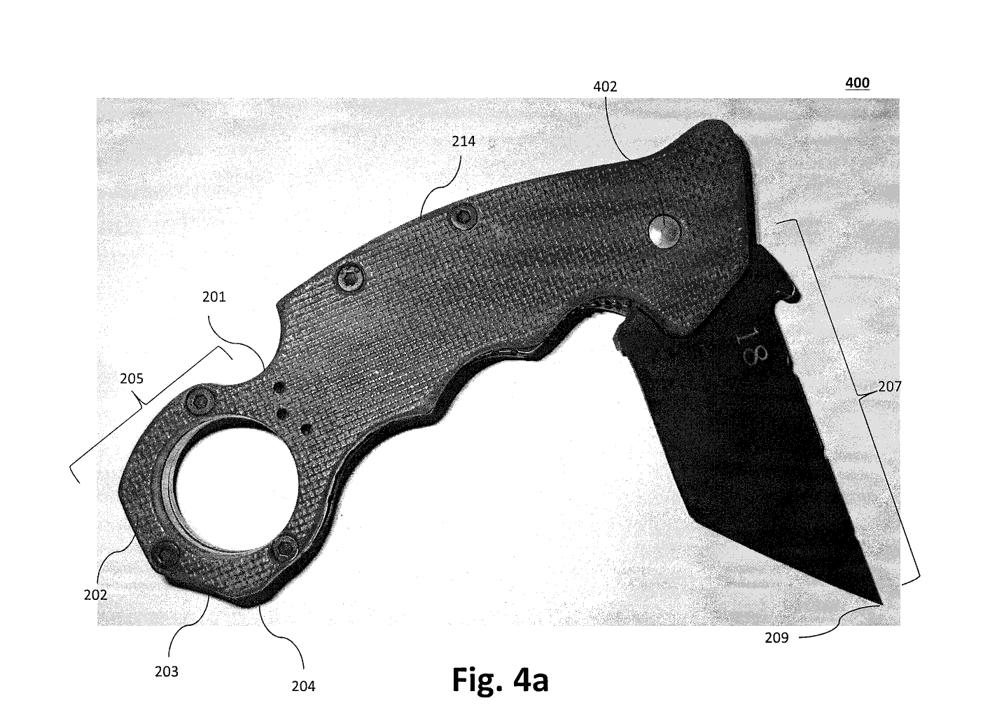

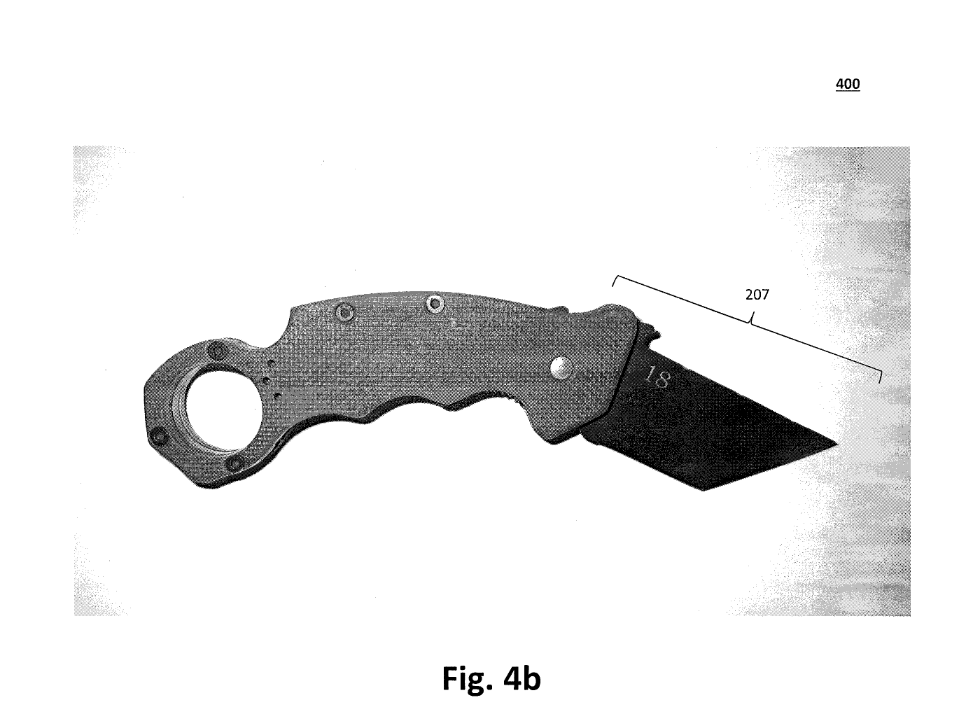

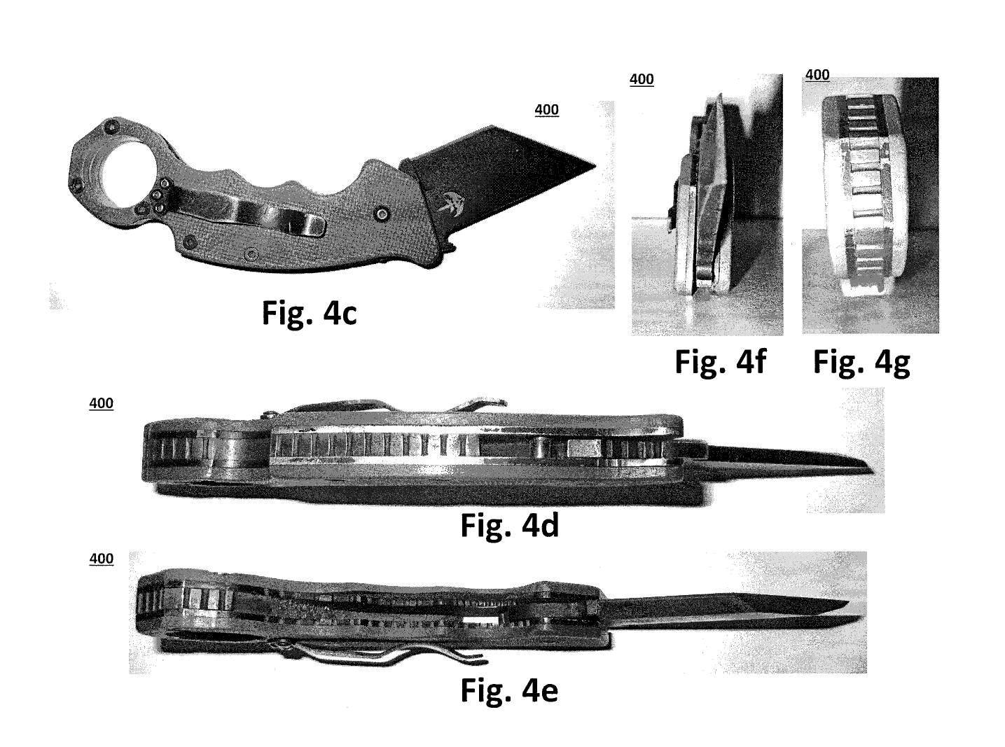

The straight edge karambit tool 200a of FIG. 2a, as well as the novel curved edge karambit tool 300a of FIG. 3a and the folding straight edge karambit 400 of FIG. 4a, further comprises, inter alia, a mid-lock portion 201, a reverse lock portion 202, a thumb lock portion 203, and a knuckle portion 204. Specifically, the safety ring portion 205 may comprise, along its outer periphery, (a) a mid-lock portion 201; (b) a thumb lock portion 203; (c) a reverse lock portion 202; and/or (d) a knuckle portion 204. Further, as illustrated, said straight edge karambit tool 200a and said curved edge karambit tool 300a may be a generally C-shaped tool having (1) a first end; (2) a second end; and (3) a spine positioned between said first end and said second end. The distance from the point 209 to the reverse lock portion 202 may be, for example, 3 to 18 inches, more preferably from 5 to 12 inches, or, most preferably, about 7.5 inches. The thickness of the tool's material may be 0.05 to 0.75 inches, more preferably from 0.10 to 0.375 inches, or, most preferably, about 0.19 inches; however, one of skill in the art would understand that thickness may be increased, or decreased, to achieve a desired strength using a particular material. That is, stronger materials may enable a thinner and/or smaller tool, while weaker materials may warrant a thicker, or larger, tool.

FIG. 2b illustrates a straight edge karambit tool 200b in accordance with an aspect of the present invention. As illustrated, a safety ring portion 205 may be positioned at the first end of the generally C-shaped tool, and a blade portion 207 is positioned at the second end of the generally C-shaped tool. The generally C-shaped tool may further comprise a plurality of holes 213 on the spine 206 and/or safety ring portion 205. The plurality of holes 213 may serve at least two purposes. First, the plurality of holes 213 reduces the overall weight of the generally C-shaped tool, thereby increasing usability and reducing fatigue by the operator during use. Second, the plurality of holes 213 can serve as an attachment means for the handle 214 or another device. For example, rivets (or another fastener) may be inserted through certain of the plurality of holes 213. Alternatively, when the handle 214 is formed over the C-shaped tool (e.g., via plastic over-molding techniques), the handle material can penetrate the plurality of holes 213, thereby fusing the handle portions positioned on each side of the tool.

The blade portion 207 may comprise an inside edge 210, an outside edge 208, and a point 209. As illustrated, a handle 214 may be configured at point A to facilitate holding of the C-shaped tool by the operator, whereby the handle 214 may be located between said safety ring portion 205 and said blade portion 215 (e.g., traversing said spine 206). The handle 214 may further comprise a gripping texture and a plurality of finger indents 212 formed on its edge to provide increased grip and/or handling The handle 214 may be sized and formed to generally comport with the size and shape of a human hand when in a gripping position. The handle 214 may be coupled, or otherwise secured, to a C-shaped tool using, for example, screws, rivets, adhesive, or through a plastic over-molding process, whereby the handle 214 is molded around the C-shaped tool. While the tools 200a, 300a illustrated in FIGS. 2a-2b and 3a-3b are generally C-shaped, other shapes are possible and anticipated. For example, the novel features disclosed herein may be similarly applied to straight tools, S-shaped tools, or other tools. For example, S-shaped tools are described by U.S. Pat. No. 7,940,510 and U.S. Patent Publication No. 2006/0042098.

The mid-lock portion 201, thumb lock portion 203, reverse lock portion 202, and/or knuckle portion 204 may be formed as an integral part of the karambit tool 200a, 300b (e.g., the C-shaped tool). In certain aspects, these portions may be molded, cut, or stamped into the outer perimeter of the safety ring portion 205 during fabrication of the tool. As will be discussed, each of these portions may serve a specific function in enhancing the performance of a karambit. For example, the mid-lock portion 201 feature is designed to allow the middle finger to comfortably rest inside its radius. The thumb lock portion 203 is slightly concave, or flat, portion to allow the thumb to be tightly and comfortably pushed against it with little or no discomfort to the operator. By holding the middle finger against the mid-lock portion 201 and the thumb firmly pushed against the thumb lock portion 203, these combined actions provide increased stability of the karambit, especially when using the karambit to strike a target with the outside edge, or inside edge, or to stab a target with the point 209. The increased stability enables improved targeting and increased striking force.

As with the thumb lock portion 203, the reverse lock portion 202 feature may be slightly concave, or flat, to allow the thumb to be tightly and comfortably pushed against it with little or no discomfort to the operator. In order to maximize the down force applied by the operator's hand and thumb, the reverse lock portion 202 may be located (e.g., in straight edge karambit 200b) in a position that is perpendicular (or substantially close to perpendicular) to the axis of the karambit, the karambit axis 211 may be defined as the line that connects the point 209 to the center of the safety ring 205. With a curved edge karambit, the reverse lock portion 202 feature provides the same effect, to a lesser extent than the straight edge karambit 200b. This is due, at least in part, to the geometry limitations in positioning the point 209 on the curved edge karambit. Tightly holding the thumb onto the reverse lock portion 202, which has a slightly concave geometry, provides improved stability, thereby reducing the chances of the karambit twisting while held in the operator's hand as compared to the thumb pushing down on a convex surface on karambits that lack such a reverse lock portion 202 feature.

A function of the knuckle portion 204 is to preserve and concentrate a punch's force by directing it toward a harder and smaller contact area, resulting in increased tissue disruption, including an increased likelihood of fracturing the victim's bones on impact. The knuckle portion 204 also spreads the operator's counter force into the karambit grip that would otherwise be absorbed by the operator's fingers, therefore reducing the likelihood of injury to the operator's fingers.

To provide an overview, the present invention may be illustrated by the following examples. These examples are provided to aid in the understanding of the invention and are merely representative of the work that contributes to the teaching of the present novel article, and is not to be restricted by the examples that follow.

### Example 1

As noted above, FIG. 2a illustrates an example of the novel straight edge karambit tool 200a having the mid-lock portion 201, the reverse lock portion 202, the thumb lock portion 203, and the knuckle portion 204. The mid-lock portion 201 may be fabricated from a continuous concave arc having a radius of, for example, 0.25 to 1.5 inches, more preferably from 0.375 to 1 inches, or, most preferably, about 0.75 inches. In certain aspects, the mid-lock portion 201 can be formed from multiple adjacent concave arcs connected to each other forming a concave geometry with such arcs cumulatively having the forgoing radii. That is, the total length of the arc, or arcs, forming the mid-lock portion 201 may be, for example, 0.25 inches to 1.0 inches. At the intersection of the spine 206 and the mid-lock portion 201, a convex geometry of one or multiple arcs, radius 0.025 to 0.5 inches or a flat surface length 0.008 to 0.50 inches may form the transition from mid-lock portion 201 to spine 206. The other end of the mid-lock portion 201, where it blends with the outer periphery of the safety ring 205, may comprise a convex geometry of one or multiple arcs or a flat surface, with a radius ranging from 0.025 to 0.5 inches and a length ranging from 0.01 to 0.5 inches, respectively. The width of the mid-lock portion 201 may be the width of the karambit at the handle (i.e., at the spine 206, including any handle 214), the width of the safety ring portion 205, or up to 50% greater than the width of the safety ring 205 or at the handle 214.

The thumb lock portion 203 may be fabricated from a continuous concave arc of radius 0.25 to 6.0 inches, more preferably from 0.5 to 4 inches, or, most preferably, about 3 inches. As with the mid-lock portion 201, the thumb lock portion 203 may comprise multiple connected concave arcs. As illustrated, the thumb lock portion 203 may be a flat surface, but may be concave. The length of the thumb lock portion 203 (whether arc or flat) may be 0.25 to 1.5 inches. The thumb lock portion 203 may be located at the outer periphery of the safety ring 205 on the opposite side of the mid-lock portion 201. The thumb lock portion 203 is located at, for example, a plane that is 10° to 100° with respect to the karambit axis 211. The thumb lock portion 203 may or may not intersect the knuckle portion 204 and the reverse lock portion 202 at the point of intersection, with either of the aforementioned features, a convex feature may be formed, comprising one or multiple arcs, with radii ranging from 0.010 to 0.5 inches, or it may be a flat surface. The thumb lock portion 203 may not intersect either the knuckle portion 204 or the reverse lock portion 202. In such instances, the transition from the thumb lock portion 203 to the outer periphery of the safety ring 205 has a convex shape, or convex shape followed by concave shape formed by one or multiple arcs with radii ranging from 0.01 to 0.5 inches. The width of the thumb lock portion 203 is the width of the karambit at the handle or the width of the safety ring or up to 50% greater than the width of the safety ring 205.

The reverse lock portion 202 may comprise a continuous concave arc, or multiple concave arcs connected to form a concave curved geometry, with a radius ranging from 0.25 to 9.0 inches (more preferably from 2 to 7 inches, or, most preferably, about 5 inches). The reverse lock portion 202 may also be a flat surface. The length of the reverse lock portion 202 (arc or flat) is 0.25 to 1.5 inches. The reverse lock portion 202 is located at the outer periphery of the safety ring 205. The reverse lock portion 202 may be located in a plane at a 90° intersection with the karambit axis 211. However, the plane angle may range between 30° and 170°, and therefore is not limited to only a 90° intersection. The reverse lock portion 202 may or may not intersect the thumb lock portion 203 and the mid-lock portion 201. At the point of intersection with either of the aforementioned features, a convex feature is formed, such that this feature comprises one or multiple arcs, with radii ranging from 0.010 to 0.5 inches (more preferably from 0.04 to 0.3 inches, or, most preferably, about 0.07 inches.) The transition may be a flat surface. The reverse lock portion 202 will not intersect either the thumb lock portion 203 or the mid-lock portion 201. In such instances, the transition from the reverse lock portion 202 to the outer periphery of the safety ring 205 is a convex shape or a convex followed by concave shape, formed by one or multiple arcs, with radii ranging from 0.005 to 0.5 inches. The width of the thumb lock portion 203 is the width of the karambit at the handle or the width of the safety ring or up to 50% greater than the width of the safety ring 205.

The knuckle portion 204 is located at the outer periphery of the safety ring 205. The knuckle portion 204 may be located on the side of the karambit that faces the inside edge 210 when C-shaped (e.g., the same side of the tool, as illustrated). The knuckle portion 204 may either be a convex arc comprising one single arc, or multiple arcs connected to each other forming a convex curve having a cumulative radius ranging from 0.05 to 5.0 inches. The knuckle portion 204 may be flat, where its length may exceed the diameter of the outer periphery of the safety ring 205 by less than 50% of the outside diameter of the safety ring 205. The knuckle portion 204 may or may not intersect the thumb lock portion 203. If these two features intersect, a convex feature is formed, such that this feature is formed from one or multiple arcs, whose radii can range from 0.005 to 0.5 inches, or the transition can be a flat surface. The knuckle portion 204 feature may not intersect the thumb lock portion 203. In such instance, the knuckle portion 204 intersects the outer diameter of the safety ring 205, then at the point of intersection, a convex arc is formed, or a convex arc is followed by a concave arc, of radii 0.005 to 0.5 inches (more preferably from 0.02 to 0.3 inches, or, most preferably, about 0.04 inches). The width of the knuckle portion 204 can vary from the width of the karambit at the handle to a sharp edge that has the same thickness as the inside or outside edges, or may have a varying thickness with the base of the knuckle having the same width of the karambit at the handle and taper into a narrow edge that may even become a sharp edge that has the same thickness as the inside or outside edges.

FIGS. 2c through 2h illustrate various views of an example straight edge karambit 200b. Specifically, FIG. 2c illustrates a top plan view of the straight edge karambit 200b having an example handle assembly 214, while FIG. 2d illustrates the opposite side of the straight edge karambit 200b. FIGS. 2e through 2h illustrate, respectively, the top side, bottom side, front end (e.g., the tip 209 end), and the rear end of the straight edge karambit 200b.

### Example 2

FIG. 3a illustrates an example of the novel curved edge karambit tool 300a with the added novel features, which include the mid-lock portion 201, the reverse lock portion 202, the thumb lock portion 203, and the knuckle portion 204 as described with regard to FIGS. 2a through 2h.

As will be appreciated from the figures, the straight edge karambit 200b and the curved edge karambit 300b share a number of correspondingly numbered components, which are described above and therefore will not be described in connection with the curved edge karambit tool 300a or the curved edge karambit tool 300b. FIG. 3b illustrates a curved edge karambit tool 300a in accordance with an aspect of the present invention. FIGS. 3c through 3h illustrate various views of an example curved edge karambit 300b assembled with a handle 214. Specifically, FIG. 3c illustrates a top plan view of the curved edge karambit 300b with an example handle assembly 214, while FIG. 3d illustrates the opposite side of the curved edge karambit 300b. FIGS. 3e through 3h illustrate, respectively, the top side, bottom side, front end (e.g., the tip 209 end), and the rear end of the curved edge karambit 300b.

### Example 3

FIG. 4a illustrates an example of a novel folding straight edge karambit 400 with the added novel features, which include the mid-lock portion 201, the reverse lock portion 202, the thumb lock portion 203, and the knuckle portion 204 as described with regard to FIGS. 2a through 2h.

As will be appreciated from the figures, the straight edge karambit 200b and the folding straight edge karambit 400 share a number of correspondingly numbered components, which are described above and therefore will not be described in connection with the folding straight edge karambit 400. Thus, the tool, whether C-shaped, S-shaped, or the like, may be fabricated using a movably coupled discontinuation material or component. To facilitate folding, for example, the blade portion 207 is configured to pivot, with regard to the spine 206 (or handle 214), about a pivoting component 404. The pivoting component 404 may be, for example, a screw, rivet, or other shaft that enables the blade portion 207 to axially rotate.

FIG. 4a illustrates the folding straight edge karambit 400 in a partly folded position, while FIG. 4b illustrates the folding straight edge karambit 400 in a fully extended position. FIGS. 4c through 4h illustrate various views of an example folding straight edge karambit 400 assembled with a handle 214. Specifically, FIG. 4c illustrates a top plan view of the folding straight edge karambit 400, while FIG. 4d illustrates the opposite side of the folding straight edge karambit 400. FIGS. 4d through 4g illustrate, respectively, the top side, bottom side, front end (e.g., the tip 209 end), and the rear end of the folding straight edge karambit 400.

The straight edge karambit 200a, the curved edge karambit 300a, and the folding straight edge karambit 200a may be fabricated from one or more of a variety of materials. Indeed, the various components may be made from metal (whether ferrous or non-ferrous) or alloys thereof, or polymer-based composite resinous materials or ceramic materials, or even a combination of these materials for different parts of the tool. For example, the blade portion 207 or the entire C-shaped tool may be fabricated from one or more of carbon steel, stainless steel, tool steel, alloy steel, cobalt and titanium alloys, ceramics, obsidian, polymer-based composite resinous materials (e.g., plastic), or equivalents thereof. The handle 214 may be fabricated from metal, metal alloys, ceramics, polymer-based composite resinous materials, or equivalents thereof. For increased rigidity and strength, the C-shaped tool may be fabricated from a single, continuous material. For example, the C-shaped tool may be cut or molded from a single piece of material (e.g., a ferrous material). In other embodiments, the C-shaped tool may be fabricated from a plurality of materials joined together (e.g., by welding or other attachment means). If the straight edge karambit 200a and/or the curved edge karambit 300a are designed to fold as illustrated in, for example, FIGS. 4a to 4g, such designs may be made from aforementioned materials used for non-folding karambit or materials similar to that used for folding knives; that is, all metal materials, or a metal blade with polymer-based composite resinous materials for parts of the handle portion and/or the ring portion.

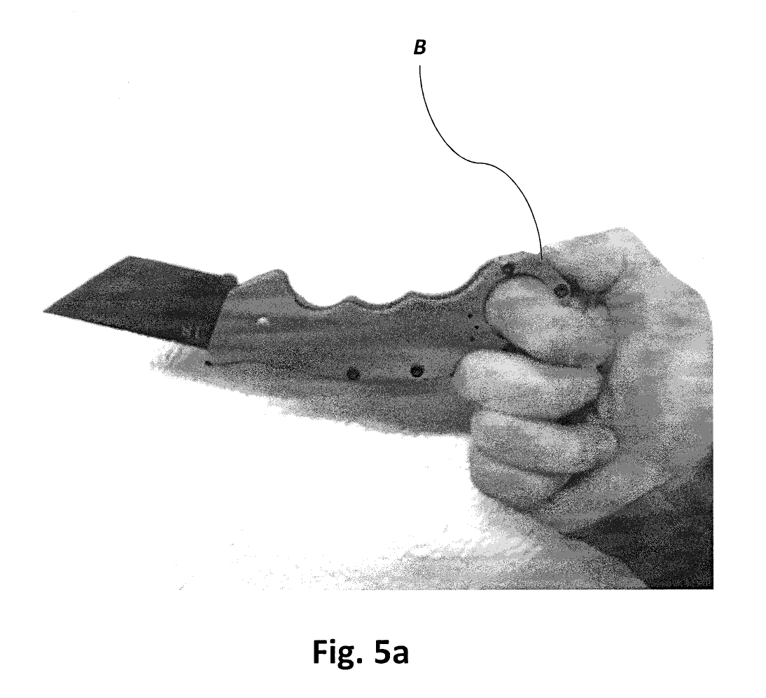

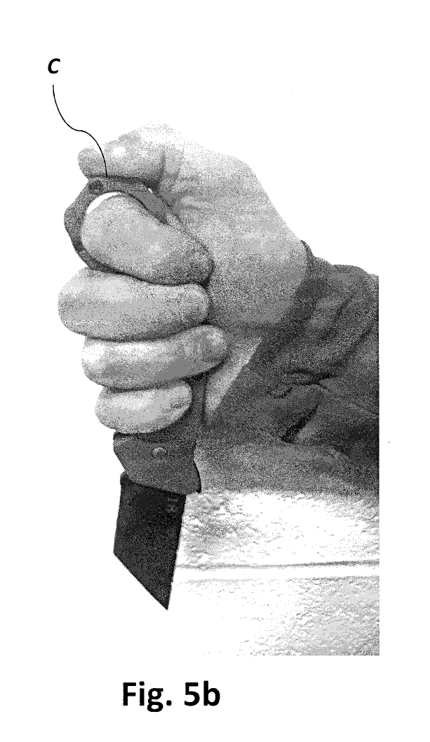

FIG. 5a illustrates the straight edge karambit having a handle in an extended grip position, wherein the operator's thumb is firmly held against the thumb lock portion 203 at point B. FIG. 5b illustrates the straight edge karambit having a handle in a reverse grip position, wherein the operator's thumb pushes firmly against the reverse lock portion 202 at point C.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

The above-cited patents, patent publications, and articles are hereby incorporated by reference in their entirety. Although various embodiments have been described with reference to a particular arrangement of parts, features, and the like, these are not intended to exhaust all possible arrangements or features, and indeed many other embodiments, modifications, and variations will be ascertainable to those of skill in the art. While the above description contains many specificities, these should not be construed as limitations on the scope of the disclosure but rather as an explanation of one preferred embodiment thereof Many other variations are possible. Accordingly, the scope of the disclosure should be determined not by the embodiment illustrated, but by the appended claims and their legal equivalents. Thus, it is to be understood that the invention may therefore be practiced otherwise than as specifically described above.

What is claimed:

1. A bladed apparatus comprising:
a generally C-shaped tool having (1) a first end; (2) a second end; and (3) a spine positioned between said first end and said second end,
wherein a safety ring portion is positioned at the first end, and a blade portion is positioned at the second end, the blade portion comprising an inside edge, an outside edge, and a point; and
wherein safety ring portion comprises along its outer periphery (a) a mid-lock portion; (b) a thumb lock portion; and (c) a reverse lock portion; and
a handle portion configured to hold said C-shaped tool, at least a portion of said handle portion being located between said safety ring portion and said blade portion.

2. The bladed apparatus of claim 1, wherein said mid-lock portion has a radial geometry.

3. The bladed apparatus of claim 1, wherein said thumb lock portion has a concave geometry.

4. The bladed apparatus of claim 1, wherein said reverse lock portion has a concave geometry.

5. The bladed apparatus of claim 1, wherein (1) said mid-lock portion has a radial geometry, (2) said thumb lock portion has a concave geometry, and (3) said reverse lock portion has a concave geometry.

6. The bladed apparatus of claim 1, wherein said generally C-shaped tool is fabricated from a single, continuous material.

7. The bladed apparatus of claim 1, wherein the C-shaped tool is fabricated from a discontinuous material, wherein the blade portion is configured to pivot with regard to the spine.

8. The bladed apparatus of claim 5, wherein said single, continuous material is a ferrous metal material.

9. The bladed apparatus of claim 5, wherein said single, continuous material is either a polymer-based composite resinous material, or a ceramic material.

10. The bladed apparatus of claim 5, wherein said handle portion is wood.

11. The bladed apparatus of claim 5, wherein said handle portion is a polymer material.

13. A bladed apparatus comprising:
a tool having (1) a first end; (2) a second end; and (3) a spine positioned between said first end and said second end,
wherein a safety ring portion is positioned at the first end, and a blade portion is positioned at the second end, the blade portion comprising an inside edge, an outside edge and a point; and
wherein safety ring portion comprises along its outer periphery (a) a mid-lock portion; (b) a thumb lock portion; and (c) a reverse lock portion; and
a handle portion configured to hold said tool, at least a portion of said handle portion being located between said safety ring portion and said blade portion.

13. The bladed apparatus of claim 12, wherein said mid-lock portion has a radial geometry.

14. The bladed apparatus of claim 12, wherein said thumb lock portion has a concave geometry.

15. The bladed apparatus of claim 12, wherein said reverse lock portion has a concave geometry.

16. The bladed apparatus of claim 12, wherein (1) said mid-lock portion has a radial geometry; (2) said thumb lock portion has a concave geometry; and (3) said reverse lock portion has a concave geometry.

17. The bladed apparatus of claim 12, wherein said tool is generally fabricated from a single, continuous material.

18. The bladed apparatus of claim 16, wherein said single, continuous material is a ferrous metal material.

19. The bladed apparatus of claim 16, wherein said single, continuous material is either a polymer-based composite resinous material, or a ceramic material.

20. The bladed apparatus of claim 16, wherein said handle portion is wood or a polymer material.
